(19) United States
(12) Patent Application Publication
(10) Pub. No.: US 2007/0091347 A1
(43) Pub. Date: Apr. 26, 2007

(54) Image forming device

(76) Inventor: Hitoshi Asaka, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,075

(22) Filed: Oct. 26, 2005

(51) Int. Cl. G06K 15/00

(52) U.S. Cl. 358/1.14; 358/1.13

(57) ABSTRACT

During initialization, functions displayed at power-on are set, and an ON or OFF setting is made with regard to the need for warm up when these functions are set, so that at power-on, set functions are displayed on the display unit 5, and whether or not to perform warm up is determined according to whether or not warm up set for the function.

### FIELD OF THE INVENTION

This invention relates to an image forming device, and for example to an image forming device, such as a multi-function machine, in which a single device functions as a copier, scanner, facsimile, printer or the like.

### BACKGROUND INFORMATION

In recent years, multi-function machines functioning as a copier, scanner, facsimile, printer or the like, combined into a single device, are becoming more common as image forming devices. A multi-function machine, when used as a copier or a printer, cannot perform operations immediately when used by a user, unless a heat source or the like, such as a heater of a fixing device or the like, is warmed up by switching the power source on beforehand.

When such multi-function machines are installed on the same floor, there is a risk that, if the power sources are simultaneously switched on for warming up, the power consumption increases temporarily, causing a breaker on a distribution circuit board to trip, or causing other electrical equipment to malfunction due to the drop in voltage, or the like. This is not limited to multi-function machines, and the same problem arises when installing several single-function copiers.

Therefore, network systems for copiers are known, in which a plurality of copiers are connected through a network line, and after the power source of one copier is switched on so as to warm the copier up and bring it to a state where copying is possible (ready state), the power sources of other copiers are sequentially switched on to start warming up. In this way, there is no overlap between warm ups, and the influence on the power voltage can be held to a minimum.

However, if such a system is applied to multi-function machines, each multi-function machine has to be connected to a network so that the plurality of multi-function machines can communicate with each other. But even if the times are shifted, in any event every multi-function machine is warmed up. However, in a multi-function machine, warm up is only necessary when executing a printer function such as when used as a copier or a fax receiver, and warm up is unnecessary when used as a fax transmitter or when used as a scanner. Therefore, there is the problem that, if warm up is performed for all the multi-function machines, power is wasted.

Therefore, an object of this invention is to provide an image forming device that performs warm up only when necessary, thereby preventing wasteful power consumption.

### SUMMARY OF THE INVENTION

This invention is an image forming device including a plurality of functions, comprising: a setting means for setting whether or not to perform warm up at power-on for each of the plurality of functions; and a control means for controlling warm up at power-on according to whether or not warm up is set for preset functions among the plurality of functions.

Preferably, the preset function is set by the setting means.

More preferably, the device comprises a function selection means for selecting any of the plurality of functions, and the control means performs the warming up in response to whether or not a function that requires warm up has been selected by the function selection means.

Preferably, the control means returns to a preset function when no function is selected by the function selection means within a predetermined time after the function requiring warming up has been used.

According to another aspect of this invention, an image forming device capable of executing a plurality of functions including a function requiring warm up and a function not requiring warm up, comprising: a setting means for setting whether or not to perform warm up at power-on for each of the plurality of functions; and a control means for performing warm up only when a function requiring warm up at power-on is selected and performance of the warm up is selected by the setting means.

According to this invention, since whether or not to warm up at power-on is controlled according to whether or not warm up is set for a set function, warm up at power-on can be rendered unnecessary other than for users who will use the printer function or the like immediately after power-on. Power consumption can be limited by eliminating this operation. In addition, the noise and the like resulting from the machine running can also be eliminated.

### BRIEF DESCRIPTION OF THE DRAWINGS

FIG. 1 is a schematic block diagram of a multi-function machine.

FIG. 2A and FIG. 2B are flowcharts showing presetting operations for a multi-function machine according to one mode of embodiment of this invention.

FIG. 3A and FIG. 3B are views showing examples of displays for setting operations according to one mode embodiment of this invention.

FIG. 4 is a flowchart showing operations when a multi-function machine according to one mode of embodiment of this invention is turned on.

FIG. 5 is a flowchart showing operations when a multi-function machine is turned on in another mode of embodiment of this invention.

### DETAILED DESCRIPTION OF THE PREFERRED EMBODIMENTS

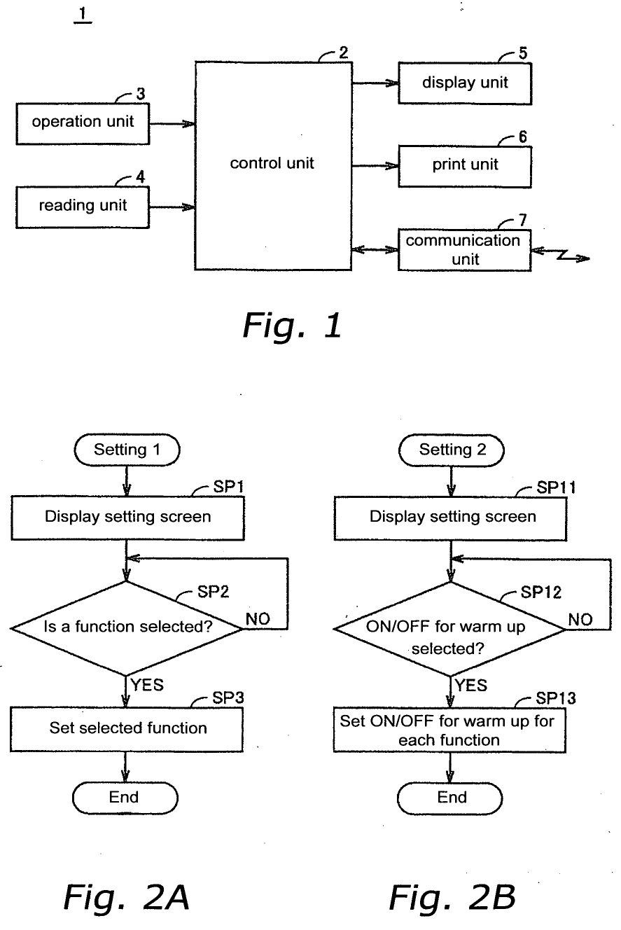

FIG. 1 is a schematic block diagram of a multi-function machine according to one mode of embodiment of this invention. In FIG. 1, a multi-function machine 1 serving as an image forming device comprises an operation unit 3 connected to a control unit 2, a reading unit 4, a display unit 5, a print unit 6 and a communication unit 7. A user operates the operation unit 3 in order to preset settings such as turning warm up on or off, and inputting the number of copies and the like, when used as a copier. The reading unit 4 reads a document or the like when the multi-function machine 1 is used as a scanner or a fax transmitter.

The display unit 5 displays the number of copies and the like when the multi-function machine 1 is used as a copier. The print unit 6 prints data and the like when the multi-function machine 1 is used as a copier or a fax receiver. The communication unit 7 sends out, through a communication line, data and the like that has been read out by the reading unit 4 when the multi-function machine 1 is used as a scanner or a fax transmitter, and receives incoming data during fax reception.

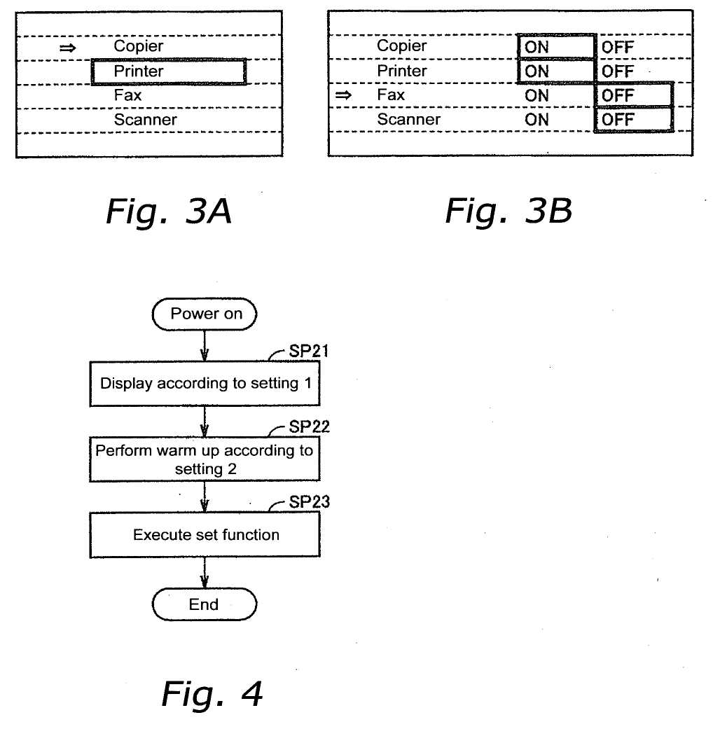

FIG. 2A and FIG. 2B are flowcharts showing presetting operations for a multi-function machine according to one mode of embodiment of this invention, and FIG. 3A and FIG. 3B are views showing examples of displays for setting operations.

First, the presetting shown in FIG. 2A and FIG. 2B is performed with the multi-function machine 1. That is to say, the function that is going to be used at power-on is set according to the flowchart shown in FIG. 2A. In step (abbreviated as SP in the figure) SP1, the control unit 2 displays each of the “copy”, “printer”, “fax” and “scanner” functions on the display unit 5 as functions of the multi-function machine 1, as shown in FIG. 3A; and looking at this display, the user operates the operation unit 3 so as to enter the functions with which the multi-function machine 1 will be started when turned on.

The control unit 2 determines whether any of the functions have been selected in step SP2, and, if it is determined that any of the functions have been selected, in step SP3 the control unit 2 causes, for example, the word “printer” to be displayed in a box to show that the printer has been selected as the selected function, and settings are made so that the device functions as a printer at power-on.

Next, warm up is set as ON or OFF for each function, as shown in FIG. 2B. In step SP11, ON/OFF is displayed on the display unit 5, as shown in FIG. 3B, according to whether or not warm up is required for each of the “copy”, “printer”, “fax” and “scanner” functions. The user looks at this display to set whether warm up should be ON or OFF for each function.

In addition, copying, printing and fax reception may be defined beforehand as functions requiring warm up when used, while the fax transmission function and scanner may be defined beforehand as functions not requiring warm up.

In step SP13, the control unit 2 determines whether ON/OFF has been selected for warm up, and if it determines that a selection has been made, it sets ON/OFF for warm up for each function. In the example shown in FIG. 3B, ON is displayed in a box for each of the copier and printer, so as to indicate that warm up has been set to ON, and for the fax and scanner, the word OFF is displayed in a box so as to indicate that warm up has been set to OFF.

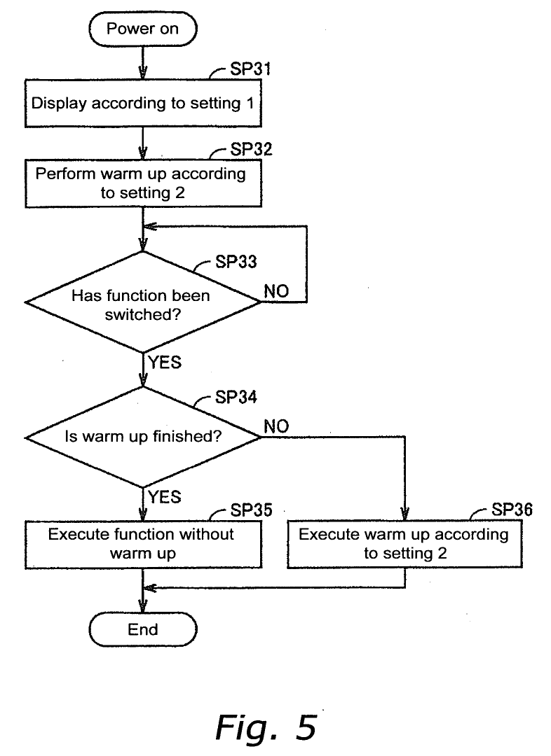

After presetting has been performed in this way, when the power source is switched on, the operations shown in FIG. 4 or FIG. 5 are performed. It should be noted that the preset may be such that the functions to be set at power-on are preset as described above, and only the setting shown in FIG. 2B is performed.

In the example shown in FIG. 4, when the power source is turned on, in step SP21, the selected function is displayed on the screen of the display unit 5 according to the presetting 1 shown in FIG. 3A. In step SP22, for instance, if copy is selected, because ON is set in the presetting 2 shown in FIG. 3B, the control unit 2 performs warm up. Then, in response to the user's operation, the set function is executed in step SP23.

In the example shown in FIG. 5, in step SP31, the function selected according to the setting 1 of FIG. 3A is displayed. Here, for instance, the fax is selected. Then, in step SP32, warm up is performed according to the setting 2 shown in FIG. 3B. If fax transmission is assumed, since there is no need to warm up, the warm up operation is not performed. If the user switches the function of the multi-function machine, the control unit 2 determines in step SP33 whether or not the function has been switched, and if the function has been switched, the control unit 2 determines in step SP34 whether or not the warm up for the selected function is already finished. If the warm up is finished, the selected function is executed in step SP35 without warm up, and if the warm up is not finished, the warm up is performed in step SP36, according to the settings of FIG. 3B.

Note that, if none of the functions is selected within a predetermined time after executing a function requiring warm up, such as copier, printer or fax reception, the device may return to a preset function.

As described in the foregoing, according to this mode of embodiment, the functions to be displayed at power-on are set, and whether or not to perform warm up when setting this function is set, so that the set function is displayed on the display unit 5 at power-on, and warm up is performed, or is not performed, according to whether or not warm up is set for the function; thus, when using functions such as, for instance, scanner or fax reception immediately after power-on, the warm up operation can be rendered unnecessary at power-on. Energy can be saved by eliminating this warm up operation and limiting power consumption. In addition, noise and the like resulting from operation of the machine can also be eliminated.

In the foregoing, a mode of embodiment of this invention was described with reference to the figures; however, this invention is not limited to the illustrated mode of embodiment. Various perfections and variations can be added to the illustrated mode of embodiment, within the scope of the present invention, or within a scope equivalent thereto.

What is claimed is:

1. An image forming device, which has a plurality of functions, comprising:
a setting means for setting whether or not to perform warm up at power-on for each of the plurality of functions; and
a control means for controlling warm up at power-on according to whether or not warm up is set for preset functions among the plurality of functions.

2. The image forming device as recited in claim 1, wherein the preset function is set by the setting means.

3. The image forming device as recited in claim 1 further comprising a function selection means for selecting any of the plurality of functions, wherein
the control means performs the warm up according whether or not a function that requires warm up has been selected by the function selection means.

4. The image forming device as recited in claim 1, wherein the control means returns to a preset function when no function is selected by the function selection means within a predetermined time after a function requiring warm up has been used.

5. An image forming device capable of executing a plurality of functions including a function requiring warm up and a function not requiring warm up, comprising:
a setting means for setting whether or not to perform warm up at power-on for each of the plurality of functions; and
a control means for performing warm up only when a function requiring warm up at power-on is selected and performance of the warm up is selected by the setting means.
